(19) United States
(12) Patent Application Publication
(10) Pub. No.: US 2025/0056233 A1
(43) Pub. Date: Feb. 13, 2025

(54) METHODS AND DEVICES FACILITATING SECURE WI-FI PAIRING

(71) Applicant: ORANGE, ISSY LES MOULINEAUX (FR)

(72) Inventors: Jean-Michel Bonnamy, Chatillon Cedex (FR); Sylvain Bale, Chatillon Cedex (FR)

(21) Appl. No.: 18/720,254

(22) PCT Filed: Dec. 8, 2022
(86) PCT No.: PCT/EP2022/084958

§ 371 Date: Jun. 14, 2024

(30) Foreign Application Priority Data
Dec. 17, 2021 (FR) FR2113926

(51) Int. Cl. H04W 12/50; H04W 12/69; H04W 48/18

(52) U.S. Cl. CPC H04W 12/50; H04W 12/69; H04W 48/18

(57) ABSTRACT

A method for associating a Wi-Fi station with a Wi-Fi access point through a first Wi-Fi network advertised by the access point. The method is implemented by the station and includes: setting up an association (of the station with the access point through a second Wi-Fi network not advertised by the access point; transmitting security information to the access point, through the second network; and setting up an association of the station with the access point through the first network, depending on the security information.

### 1. FIELD OF THE INVENTION

The invention relates to the field of IEEE 802.11 networks, i.e. of so-called Wi-Fi networks, and more particularly to the field of pairing a station (STA) with an access point (AP).

### 2. PRIOR ART

Easy pairing between STA and AP, with an acceptable level of security, is prized both by customers and by operators providing customers with peripheral equipment, i.e. STA's and/or the residential gateway, i.e. the AP. The equipment to be paired is for example a “set top box” allowing television programs to be accessed, a Wi-Fi repeater allowing the range of the Wi-Fi signal to be extended, etc., and is intended for users many of whom form part of an audience that is not always well versed in use of digital technology.

The pairing method known as WPS (acronym of Wi-Fi Protected Setup) is due to be replaced by DPP (acronym of Device Provisioning Protocol), also known by its trade name Easy Connect™, which is specified by the organization Wi-Fi Alliance. DPP relies on the use of third-party equipment, a smartphone for example, in addition to the STA and AP that are to be paired. The smartphone is used to exchange security information, such as a cryptographic key for example, between the STA and AP, in order to ensure strong authentication of the STA and to increase the general security level of the connection that will be set up. This requires a specific mobile application to be installed on the smartphone. Compared to WPS where the customer only had to press a button on the equipment to trigger pairing, the constraints imposed by DPP are excessive for some users.

One of the aims of the invention is to remedy these drawbacks of the prior art.

### 3. SUMMARY OF THE INVENTION

The situation is improved by the invention through use of a method for associating a Wi-Fi station with a Wi-Fi access point through a first Wi-Fi network advertised by the access point, the method being implemented by the station and comprising:
setting up an association of the station with the access point through a second Wi-Fi network not advertised by the access point,
transmitting security information to the access point, through the second network,
setting up an association of the station with the access point through the first network, depending on the security information.

By virtue of this method, the association of the station with the first network is secured on the basis of information that is not exchanged over this first network, i.e. at a time when it is not yet secure. Advantageously, the security information is exchanged over a second network supported by the same Wi-Fi access point but the identifier of which is not broadcast, unlike the identifier of the first network. The expression “network advertised by an access point” in the present context means that the access point broadcasts an identifier of said network in order to allow a connection to be set up. Conversely, the expression “network not advertised by an access point” in the present context means that the access point does not broadcast an identifier of said network, but does not mean that connection to that network is impossible.

The security information is for example a cryptographic key specific to the station, which allows the access point to authenticate the station and to encrypt the data that it transmits thereto. With such security information, it is possible for the access point to authenticate the station using an existing protocol such as DPP.

Use of this second Wi-Fi network may be limited to the transmission of the security information. The existence of this second network is known only to the station, which knows in advance its SSID, which is an empty string if the access point broadcasts beacons for this second network, or any string if the access point does not broadcast beacons for this second network.

In addition, since the station provides the security information directly to the access point, no intervention by third-party equipment or the user is required.

Since the SSID of the second network is not broadcast by the access point, the station must know it in advance, for example as a result of having been configured before its first use.

According to one aspect of the invention, prior to the association through the second network, the station receives a beacon from the access point, the beacon containing an identifier of the second network equal to an empty string.

In a first embodiment, the access point broadcasts the identifier of the second network, for example in a beacon, but the SSID field of the beacon is left empty, as though the identifier of the second network were an empty string.

Thus, the identifier, or the real identifier, of the second Wi-Fi network remains hidden from equipment other than the station, i.e. from equipment not intended to associate with the first Wi-Fi network of the access point, even though the access point broadcasts beacons for this second network.

Thus, the station may respond to the beacon according to the Wi-Fi standard. According to the invention, the station uses the empty string as the identifier of the second network in a procedure allowing association with the access point, for example in a probe request.

According to one aspect of the invention, prior to the association through the second network, the station does not receive a beacon from the access point advertising the second network.

In a second embodiment, the access point does not broadcast beacons to advertise the existence of the second network.

Thus, the identifier of the second Wi-Fi network remains hidden from equipment other than the station, i.e. from equipment not intended to associate with the first Wi-Fi network of the access point.

Thus, according to the Wi-Fi standard, the station may initiate the association procedure without receiving a beacon. According to the invention, the station uses the string corresponding to the identifier of the second network, which the station knows in advance, in a procedure allowing association with the access point, for example in a probe request.

According to one aspect of the invention, the association method is triggered by start-up of the station.

Thus, no user intervention on the station is required. For example, if the station is a “set-top box” or a Wi-Fi repeater, the user simply needs to take it out of its packaging and turn it on, after she or he has purchased it. Subsequently, if the station becomes disassociated from the access point, it is enough to restart the station or restore it to factory settings to re-associate it with the first Wi-Fi network of the access point.

According to one aspect of the invention, the association method comprises removing the association of the station with the access point through the second Wi-Fi network, before the association of the station with the access point through the first Wi-Fi network.

Thus, the association between STA and AP is closed at the initiative of the station as soon as the security data have been exchanged. This frees up resources for the access point to use and, in the case where the station is able to associate only with a single access point at a time, this allows it to associate again with another access point, whether virtual or not.

According to one aspect of the invention, the association method comprises receiving, through the second network, security information from the access point.

Thus, the station may also perform security operations such as authenticating the access point or encrypting the data that it transmits thereto. Security is then mutualized between the station and the access point.

The various aspects of the association method, implemented by the station and which have just been described, may be implemented independently of one another or in combination with one another.

The invention also relates to a method for associating a Wi-Fi station with a Wi-Fi access point through a first Wi-Fi network advertised by the access point, the method being implemented by the access point and comprising:
setting up an association of the station with the access point through a second Wi-Fi network not advertised by the access point,
receiving security information from the station, through the second network,
setting up an association of the station with the access point through the first network, depending on the security information.

It will be understood that the association is carried out by the access point, through the second network, only if the station supplies the identifier that the access point expects for this second network, which however is not broadcast by the access point.

The security information provided by the station is used only if this condition is met, this increasing the security level of the association of the station with the first network.

According to one aspect of the invention, prior to the association through the second network, the access point transmits a beacon, the beacon containing an identifier of the second network equal to an empty string.

This corresponds to the first embodiment, implemented by the access point.

According to one aspect of the invention, prior to the association through the second network, the access point does not transmit a beacon advertising the second network.

This corresponds to the second embodiment, implemented by the access point.

According to one aspect of the invention, the association method comprises removing the association of the station with the access point through the second Wi-Fi network, before the association of the station with the access point through the first Wi-Fi network.

Thus, the association between STA and AP is closed at the initiative of the access point as soon as the security data is exchanged. This frees up resources for the access point to use and, in the case where the station is able to associate only with a single access point at a time, this allows it to associate again with another access point, whether virtual or not.

According to one aspect of the invention, the security information is ignored if it is received outside a time window opened by a user action on the access point.

Thus, the security level of the association with the first network is increased, again without any intervention by third-party equipment.

The user action is, for example, a press on a specific button, sometimes called the pairing button, positioned on the casing of the access point, in order to open a limited time window during which the access point waits for data from the station. Thus, the probability that this data will be received and processed by another access point located nearby and supporting a network with the same identifier as the second network is considerably reduced.

According to one aspect of the invention, the association method comprises transmitting, to the station, through the second network, security information from the access point.

The security information transmitted by the access point to the station is, for example, a cryptographic key specific to the access point. Thus, the station may also perform security operations such as authenticating the access point or encrypting the data that it transmits to the access point. Security is then mutualized between the station and the access point.

According to one aspect of the invention, the security information is ignored if it does not correspond to a datum received separately from a terminal separate from the station.

Thus, the access point sets up the second association only if the security information received using the first association is confirmed by a datum received via another channel. This for example prevents a station close to the access point, but not intended or authorized to associate with the access point, from permanently associating with the access point. The datum in question is for example a hash of the security information, featuring in a QR code displayed on the casing of the authorized station. The separate terminal is for example a smartphone connected via Wi-Fi to the access point and used to capture the QR code.

The various aspects of the association method, implemented by the access point and which have just been described, may be implemented independently of one another or in combination with one another.

The association methods implemented by the station and by the access point are separate methods.

The invention also relates to a device for associating a Wi-Fi station with a Wi-Fi access point through a first Wi-Fi network advertised by the access point, the device being comprised in the station and comprising a receiver, a transmitter, a processor and a memory that is coupled to the processor and contains instructions that are intended to be executed by the processor to:
set up an association of the station with the access point through a second Wi-Fi network not advertised by the access point,
transmit security information to the access point, through the second network,
set up an association of the station with the access point through the first network, depending on the security information.

This device, which is able to implement all of the embodiments of the association method that has just been described, is intended to be implemented in a Wi-Fi station.

The invention also relates to a device for associating a Wi-Fi station with a Wi-Fi access point through a first Wi-Fi network advertised by the access point, the device being comprised in the access point and comprising a receiver, a transmitter, a processor and a memory that is coupled to the processor and contains instructions that are intended to be executed by the processor to:
set up an association of the station with the access point through a second Wi-Fi network not advertised by the access point,
receive security information from the station, through the second network,
set up an association of the station with the access point through the first network, depending on the security information.

This device, which is able to implement all of the embodiments of the association method that has just been described, is intended to be implemented in a Wi-Fi access point.

The invention also relates to a computer program comprising instructions which, when these instructions are executed by a processor, cause the latter to implement the steps of the association method implemented by a Wi-Fi station, that has just been described.

The invention also relates to an information medium that is readable by a Wi-Fi station, and that comprises computer-program instructions such as mentioned above.

The invention also relates to a computer program comprising instructions which, when these instructions are executed by a processor, cause the latter to implement the steps of the association method implemented by a Wi-Fi access point, that has just been described.

The invention also relates to an information medium that is readable by a Wi-Fi access point, and that comprises computer-program instructions such as mentioned above.

The aforementioned programs may use any programming language, and take the form of source code, object code, or of code intermediate between source code and object code, such as code in a partially compiled form, or in any other desirable form.

The aforementioned information media may for be any entity or device capable of storing the program. For example, a medium may include a storage means, such as a ROM, for example a CD-ROM or a microelectronic circuit ROM, or else a magnetic recording means.

Such a storage means may, for example, be a hard disk, a flash memory, etc. Moreover, an information medium may be a transmissible medium such as an electrical or optical signal, which may be routed via an electrical or optical cable, by radio or by other means. A program according to the invention may in particular be downloaded from a network such as the Internet.

Alternatively, an information medium may be an integrated circuit into which a program is incorporated, the circuit being configured to execute or to be used in the execution of the methods in question.

### 4. PRESENTATION OF THE FIGURES

Other advantages and features of the invention will become more clearly apparent on reading the following description of one particular embodiment of the invention, which embodiment is given by way of simple illustrative and non-limiting example, and the appended drawings, in which:

FIG. 1 shows one example of implementation of the method for associating a Wi-Fi station with a Wi-Fi access point, according to embodiments of the invention,

FIG. 2 shows one example of a structure of a device in a Wi-Fi station, implementing the method for associating the Wi-Fi station with a Wi-Fi access point, according to one aspect of the invention,

FIG. 3 shows one example of a structure of a device in a Wi-Fi access point, implementing the method for associating a Wi-Fi station with the Wi-Fi access point, according to one aspect of the invention.

### 5. DETAILED DESCRIPTION OF AT LEAST ONE EMBODIMENT OF THE INVENTION

In the remainder of the description, it is understood that the invention applies to all versions of the standards IEEE 802.11. The term SSID among others, identifying a Wi-Fi access point, is merely one example of ways to identify a Wi-Fi access point, whether physical or virtual.

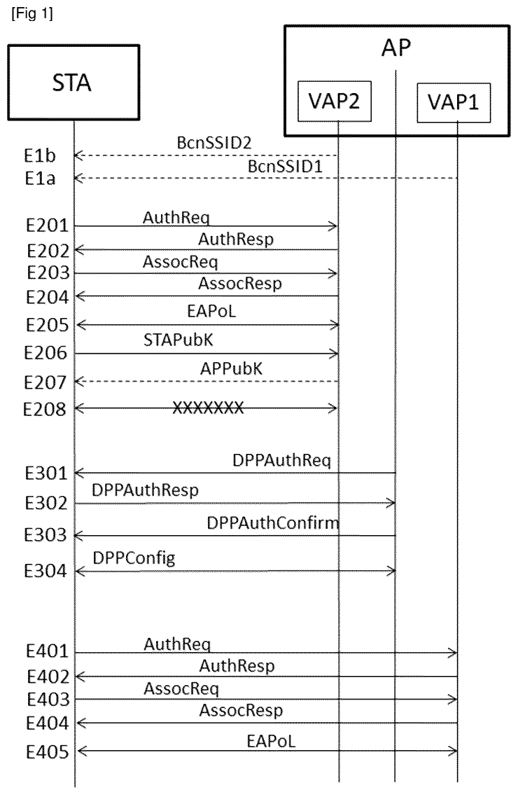

FIG. 1 shows an example of implementation of the method for associating a Wi-Fi station with a Wi-Fi access point, according to embodiments of the invention.

The following examples are based on use of DPP as a security protocol for the association of a Wi-Fi station with a Wi-Fi access point identified by an identifier SSID1. The invention is applicable to any security protocol based on a prior exchange of security information such as, for example, cryptographic keys.

Pairing designates all the operations performed between a station and a Wi-Fi access point to set up a connection between the station and a network through this access point. Pairing is therefore done in a plurality of phases, described below according to embodiments of the invention. The first phase of pairing is the bootstrapping phase, during which the station STA temporarily associates itself with the physical access point AP, in order to transmit thereto and receive the security information required by a security protocol, for example the DPP protocol. Once the security information has been transmitted between the station STA and the access point AP, the temporary association is terminated.

After the bootstrapping phase come phases of authentication and configuration, for example performed according to the DPP protocol.

Lastly, pairing ends with the phase of associating the station with the access point AP, based on the identifier SSID1.

The access point AP is for example a domestic gateway for accessing the Internet, such as, for example, a Livebox from the operator Orange (Livebox and Orange are registered trademarks). The access point AP is preconfigured to broadcast an SSID identifier, SSID1, for example by means of beacons. The access point AP is also preconfigured with a second SSID identifier, SSID2, which may not be broadcast. Technically, the coexistence of the 2 identifiers SSID1 and SSID2 may for example be achieved via the existence of two logical interfaces (or virtual access points) VAP1 and VAP2 on the physical interface of the access point, respectively, associated with the identifiers SSID1 and SSID2, respectively. The logical interfaces are also called virtual access points; the two terms are used interchangeably throughout the rest of the document. For convenience, the names VAP1 and VAP2 are also given to the Wi-Fi networks accessible through these points, respectively.

It will be understood that the virtual access points VAP1 and VAP2 are contained in the physical access point AP. If the access point AP possesses a plurality of physical interfaces, for example one at 2.4 GHz and one at 5 GHZ, the virtual access points VAP1 and VAP2 may be present on each of the physical interfaces, or only on one of the two.

According to the invention, the bootstrapping phase takes place on logical interface VAP2 of the access point AP, and the associating phase takes place on logical interface VAP1 of the access point AP. The logical interface VAP1 is moreover the one on which the equipment of the local Wi-Fi network, such as the station STA, is intended to set up a lasting association, for example to serve as a medium for a connection of the station STA to the Internet, through the access point. The authentication and configuration phases specific to DPP use the physical interface of the access point AP and do not need to distinguish between the two logical interfaces of the access point AP. The station STA also associates with the access point AP during the bootstrapping phase, but on logical interface VAP2 and not on logical interface VAP1.

The station STA may be any piece of equipment intended to connect to the local Wi-Fi network offered by the access point AP. For example, the station STA is a Wi-Fi repeater allowing the Wi-Fi coverage of the Livebox to be increased, or allowing the Wi-Fi version of the Livebox to be replaced by a more recent version (Wi-Fi 5 by Wi-Fi 6 for example). The station STA is configured, before its first use, to know the identifier SSID2 of the access point AP, and the associated passphrase. According to the invention, the station therefore knows in advance at least the credentials required to associate with the virtual access point VAP2 identified by SSID2.

Next, to associate it with the virtual access point VAP1 identified by SSID1, the credentials may be requested by the access point from the station using a known technique.

In a first embodiment, the virtual access point VAP2 of the access point AP broadcasts beacons in order to let itself be discovered by a station, but the beacons contain an SSID field left empty. In other words, if there is a non-empty string, SSID2, corresponding to an identifier of VAP2, this string is not broadcast by the access point AP. The station STA knows this fact and responds to such a beacon with a probe request containing an SSID field also left empty.

In a second embodiment, the virtual access point VAP2 of the access point AP does not broadcast any beacons. In other words, the non-empty string SSID2, corresponding to an identifier of VAP2, is not broadcast by the access point AP. The station STA knows this fact and transmits a probe request containing an SSID field equal to SSID2, without waiting for a corresponding beacon from the access point VAP2.

In a third embodiment, the virtual access point VAP2 of the access point AP broadcasts beacons with an SSID field containing a non-empty string equal to SSID2. The station STA knows SSID2 in advance and responds to such a beacon with a probe request containing SSID2.

In both the first and second embodiments, the access point AP does not broadcast an identifier SSID2 that is any other than an empty string.

In a regularly repeated step E1a, the virtual access point VAP1 transmits beacons BcnSSID1 containing its identifier SSID1, in order to advertise to surrounding stations the availability of this access point identified by SSID1. This step E1a may be omitted if the virtual access point VAP1 responds with its identifier SSID1 to spontaneous probe requests from stations.

In a regularly repeated step E1b, in the first embodiment only, the virtual access point VAP2 transmits beacons BcnSSID2 in order to advertise to surrounding stations the availability of this access point, but leaves the SSID field of each beacon empty, i.e. makes it equal to an empty string.

In the second embodiment, step E1b is not carried out.

In all the embodiments, the station STA, even though it has already received beacons with the identifier SSID1, does not yet associate with the access point AP based on the identifier SSID1. Instead, the station STA performs the bootstrapping phase.

In steps that have not been illustrated, the station and the access point exchange their respective capabilities, for example by means of a probe request transmitted by the station STA and containing the identifier SSID2 (empty in the case of the first embodiment), and of a probe response transmitted by the access point for the network identified by SSID2, i.e. VAP2.

In a step E201, the station STA transmits an authentication request AuthReq to the virtual access point VAP2.

In a step E202, in response the station STA receives an authentication response AuthResp from the virtual access point VAP2.

In a step E203, the station STA transmits an association request AssocReq to the virtual access point VAP2.

In a step E204, in response the station STA receives an association response AssocResp from the virtual access point VAP2.

In a step E205, the station STA and the virtual access point VAP2 exchange EAPol messages allowing the access point to obtain the credentials of the station STA, giving it the right to associate with VAP2. These credentials for example include the passphrase corresponding to the identifier SSID2.

Steps E201 to E205 are known and meet Wi-Fi standards.

The station STA is then associated with the virtual access point VAP2. It is also said that the station STA is associated with the physical access point AP via its virtual access point VAP2.

It is through this first association that the security information necessary for another association, i.e. that between the station STA and the virtual access point VAP1 (or in other words the physical access point AP via the logical interface VAP1 thereof identified by SSID1), is exchanged.

In a step E206, the station STA transmits, to the access point VAP2 only, first security information STAPubK, for example its cryptographic key. This key is for example a public or private encryption key, or any type of cryptographic material. The security information is for example included in an https frame.

In a variant common to the two embodiments, referred to as the symmetric variant, in a step E207, the access point VAP2 transmits, to the station STA only, second security information APPubK, for example the cryptographic key of the virtual access point VAP2. This key is preferably in the same format as the first security information.

In a step E208, the temporary association between the station STA and the virtual access point VAP2 is closed, either at the initiative of the station or at the initiative of the access point. The access point VAP2, after optionally acknowledging receipt of the https frame containing the security information of the station, transmits a disassociation or deauthentication message to the station STA. Alternatively, the station STA may, after having received the acknowledgment of the https frame, transmit a disassociation or deauthentication message to the access point.

In the symmetric variant, if the cryptographic key of the access point is transmitted after the cryptographic key of the station, the station STA, optionally after acknowledging receipt of the https frame containing the security information of the access point, transmits a disassociation or deauthentication message to the access point VAP2. Alternatively, the access point VAP2 may, after having received the acknowledgment of the https frame, transmit a disassociation or deauthentication message to the station STA.

With closure of the temporary association, the bootstrapping phase ends, and the DPP authentication and configuration phases may begin.

Optionally, in order to prevent an unplanned or unauthorized station located nearby the access point AP, i.e. a station other than the station STA, from lastingly associating with the access point after having successfully completed the steps described above, the access point awaits confirmation in the form of a datum received separately from a trusted terminal separate from the station STA. If this datum does not correspond to the security information already received from the station, this means that the security information and the datum do not relate to the same station. In this case, the access point does not set up an association through the network VAP1.

The datum in question is for example a hash of the security information, featuring in a QR code displayed on the casing of the authorized station. The separate terminal is for example a smartphone connected via Wi-Fi to the access point and used to capture the QR code. The datum may be received by the access point at any time, even prior to the start of the association method in order to be stored by the access point AP in anticipation of association of the station STA. Alternatively to the QR code, the datum may also be transmitted from the station STA to the smartphone via near-field communication (NFC) or Bluetooth.

In the context of the DPP protocol, which is merely one example of a protocol usable in the context of the invention, in a step E301, using a known technique, the physical access point AP transmits to the station STA an authentication request message DPPAuthRq containing at least one element encrypted with the public key of the station STA. This element comprises at least said public key of the station STA. If the station STA, on decrypting this element by means of its private key, discovers its own public key, it transmits, in a step E302, using a known technique, an authentication response message DPPAuthResp containing at least one piece of information relating to the capabilities of the station STA. In a step E303, using a known technique, if these capabilities are acceptable to the access point AP, it transmits a message DPPAuthConfirm. In the symmetric variant, in a known manner, steps E301 and E302 also include an element encrypted by the station STA using the public key of the access point.

Also in the context of the DPP protocol, which is merely one example of a protocol usable in the context of the invention, in a step E304, using a known technique, the station STA and the access point AP exchange configuration messages DPPConfig using a cryptographic key exchanged beforehand in steps E301 to E303.

Once the (one-way or two-way) strong authentication has been carried out via steps E301 to E304, the station STA may then associate itself with the physical access point AP via the logical interface VAP1 thereof identified by the identifier SSID1.

In other words, if the DPP authentication and configuration phases, which were based on the one or more cryptographic keys exchanged through the first temporary association through the network VAP2, have proceeded correctly, then a lasting association of the station STA with the access point AP through the network VAP1 is authorized. It will be understood that this lasting association therefore depends on security information exchanged during the bootstrapping phase, in the course of which a temporary association was set up.

This association is carried out in steps E401 to E405, which are similar to steps E201 to E205 described above, but with SSID1 instead of SSID2.

It will be understood that the bootstrapping phase (steps E201 to E208) according to the invention, which allowed a cryptographic key to be transmitted from the station STA to the access point AP (and, vice versa, a cryptographic key to be transmitted from the access point AP to the station STA in the case of two-way authentication), requires no intervention by a third-party terminal, and no intervention by the user of the station STA, and therefore no user interface on the station STA, contrary to the prior art. The authentication and configuration phases, which are for example performed according to the DPP protocol, remain unchanged while preserving the same level of security. Thus, the station STA associates with the access point AP on the basis of the identifier SSID1 with the same security level as that provided by the DPP protocol.

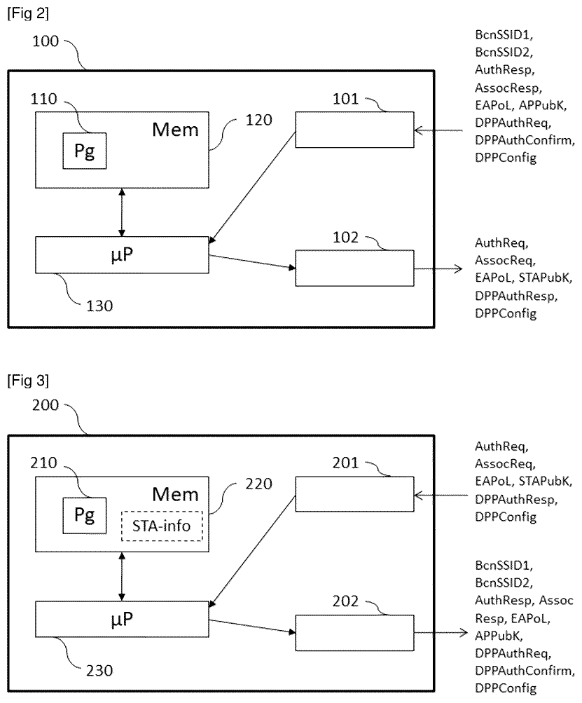

FIG. 2 shows one example of a structure of a device in a Wi-Fi station, implementing the method for associating the Wi-Fi station with a Wi-Fi access point, according to one aspect of the invention.

The device 100 implements the association method, various embodiments of which have just been described.

Such a device 100 may be implemented in a Wi-Fi station, such as the station STA for example, which may be a TV decoder, a Wi-Fi repeater, or any other terminal able to connect to a Wi-Fi network.

For example, the device 100 comprises: a receiver 101; a transmitter 102; and a processing unit 130, which is for example equipped with a microprocessor μP, and controlled by a computer program 110, that is stored in a memory 120 and that implements the association method according to the invention. On initialization, the code instructions of the computer program 110 are for example loaded into a RAM memory, before being executed by the processor of the processing unit 130.

Such a memory 120, such a processor of the processing unit 130, such a receiver 101 and such a transmitter 102 are able and configured to:
set up an association of the station with the access point through a second Wi-Fi network not advertised by the access point,
transmit security information to the access point, through the second network,
set up an association of the station with the access point through a first Wi-Fi network advertised by the access point, depending on the security information.

Advantageously, they are also able and configured to:
trigger the steps of the method following start-up of the station,
receive a beacon from the access point, the beacon containing an identifier of the second network equal to an empty string,
receive, through the second network, security information from the access point,
remove the association of the station with the access point through the second Wi-Fi network, before the association of the station with the access point through the first Wi-Fi network is set up.

FIG. 3 shows one example of a structure of a device in a Wi-Fi access point, implementing the method for associating a Wi-Fi station with the Wi-Fi access point, according to one aspect of the invention.

The device 200 implements the association method, various embodiments of which have just been described.

Such a device 200 may be implemented in a Wi-Fi station, such as the access point AP for example, which may be a residential router or gateway for accessing the Internet.

For example, the device 200 comprises: a receiver 201; a transmitter 202; and a processing unit 230, which is for example equipped with a microprocessor μP, and controlled by a computer program 210, that is stored in a memory 220 and that implements the association method according to the invention. On initialization, the code instructions of the computer program 210 are for example loaded into a RAM memory, before being executed by the processor of the processing unit 230.

Such a memory 220, such a processor of the processing unit 230, such a receiver 201 and such a transmitter 202 are able and configured to:
set up an association of the station with the access point through a second Wi-Fi network not advertised by the access point,
receive security information from the station, through the second network,
set up an association of the station with the access point through a first Wi-Fi network advertised by the access point, depending on the security information.

Advantageously, they are also able and configured to:
prior to the association through the second network, transmit a beacon, the beacon containing an identifier of the second network equal to an empty string.
prior to the association through the second network, to not transmit a beacon advertising the second network,
remove the association of the station with the access point through the second Wi-Fi network, before the association of the station with the access point through the first Wi-Fi network is set up,
ignore the security information if it is received outside a time window opened by a user action on the access point,
transmit to the station, through the second network, security information from the access point,
ignore the security information if it does not correspond to a datum received separately from a terminal separate from the station.

The described entities included in the devices described with reference to FIGS. 2 and 3 may be hardware or software entities. FIGS. 2 and 3 illustrate just one particular way out of multiple possible ways of implementing the method described above in relation to the preceding figures. Indeed, the technique of the invention may be carried out equally well on a reprogrammable computing machine (a PC, a DSP or a microcontroller) executing a program comprising a sequence of instructions or on a dedicated computing machine (for example a set of logic gates such as an FPGA or an ASIC, or any other hardware module).

If the invention is installed on a reprogrammable computing machine, the corresponding program (that is to say the sequence of instructions) may be stored on a removable storage medium (such as for example a USB stick, a floppy disk, a CD-ROM or a DVD-ROM) or a non-removable storage medium, this storage medium being able to be read partially or completely by a computer or a processor.

1. A method for associating a Wi-Fi station with a Wi-Fi access point through a first Wi-Fi network advertised by the access point, the method being implemented by the station and comprising:
setting up an association of the station with the access point through a second Wi-Fi network not advertised by the access point,
transmitting security information to the access point, through the second network, and
setting up an association of the station with the access point through the first network, depending on the security information.

2. The method as claimed in claim 1, wherein, prior to setting up an association through the second network, the station receives a beacon from the access point, the beacon containing an identifier of the second network equal to an empty string.

3. The method as claimed in claim 1, wherein, prior to setting up the association through the second network, the station does not receive a beacon from the access point advertising the second network.

4. The method as claimed in claim 1, wherein the method is triggered by start-up of the station.

5. The method as claimed in claim 1, comprising removing the association of the station with the access point through the second Wi-Fi network, before setting up the association of the station with the access point through the first Wi-Fi network.

6. The method as claimed in claim 1, comprising receiving, through the second network, security information from the access point.

7. A method for associating a Wi-Fi station with a Wi-Fi access point through a first Wi-Fi network advertised by the access point, the method being implemented by the access point and comprising:
setting up an association of the station with the access point through a second Wi-Fi network not advertised by the access point,
receiving security information from the station, through the second network, and
setting up an association of the station with the access point through the first network, depending on the security information.

8. The method as claimed in claim 7, wherein, prior to setting up the association through the second network, the access point transmits a beacon, the beacon containing an identifier of the second network equal to an empty string.

9. The method as claimed in claim 7, wherein, prior to setting up the association through the second network, the access point does not transmit a beacon advertising the second network.

10. The method as claimed in claim 7, comprising removing the association of the station with the access point through the second Wi-Fi network, before setting up the association of the station with the access point through the first Wi-Fi network.

11. The method as claimed in claim 7, wherein the security information is ignored if the security information is received outside a time window opened by a user action on the access point.

12. The method as claimed in claim 7, comprising transmitting, to the station, through the second network, security information from the access point.

13. The method as claimed in claim 7, wherein the security information is ignored if it the security information does not correspond to a datum received separately from a terminal separate from the station.

14. A device for associating a Wi-Fi station with a Wi-Fi access point through a first Wi-Fi network advertised by the access point, the device being comprised in the station and comprising:
a receiver, a transmitter, a processor and a memory that is coupled to the processor and contains instructions that when executed by the processor configure the device to:
set up an association of the station with the access point through a second Wi-Fi network not advertised by the access point,
transmit security information to the access point, through the second network, and
set up an association of the station with the access point through the first network, depending on the security information.

15. A device for associating a Wi-Fi station with a Wi-Fi access point through a first Wi-Fi network advertised by the access point, the device being comprised in the access point and comprising:
a receiver, a transmitter, a processor and a memory that is coupled to the processor and contains instructions that when executed by the processor configure the device to:
set up an association of the station with the access point through a second Wi-Fi network not advertised by the access point,
receive security information from the station, through the second network, and
set up an association of the station with the access point through the first network, depending on the security information.
